(19) United States
(12) Patent Application Publication
(10) Pub. No.: US 2005/0275619 A1
(43) Pub. Date: Dec. 15, 2005

(54) Apparatus for cursor control and method thereof

(76) Inventor: Chwan-Jaw Kao, Hsin-Chuang City (TW)

Correspondence Address: THOMAS, KAYDEN, HOSTEMEYER & RISLEY LLP, 100 GALLERIA PARKWAY, SUITE 1750, ATLANTA, GA, 30339, US

(21) Appl. No.: 10/864,215

(22) Filed: Jun. 9, 2004

(51) Int. Cl. G09G 5/00; G09G 5/08

(52) U.S. Cl. 345/156

(57) ABSTRACT

A method for cursor and application control using a hand held device. First, a movement is detected by the hand held device. A position differential is calculated according to the detected movement. Then, the hand held device transmits the position differential to a specific device wirelessly to control cursor activity accordingly, and operate an application on the specific device according to the cursor activity.

### BACKGROUND

The present invention relates to an apparatus for cursor control and method thereof, and particularly to an apparatus and method using a hand held device to provide wireless cursor and application control on specific devices.

Currently, for cursor control, computers provide touch pad, trackpoints as introduced by IBM, and mouse pointers. Touch pads provide flat surfaces to receive movement input from fingers, and convert the movement to axes to control a cursor. The trackpoints are pressure sensitive pointing devices, detecting pressure from a small circular surface to direct cursor movement. For most users, such small contact points do not provide adequate control and response. It is thus inaccurate and inconvenient to control cursor via touch pads and trackpoints.

For portable devices, such as laptops and notebooks, rather than touch pads and trackpoints, mouse pointers are generally accepted and acknowledged as providing convenient and efficient control of cursors. However, the need for extra devices negates the portability advantage of such devices. Hand held device use, in particular, presents a need for a solution to this problem.

### SUMMARY

Accordingly, an object of the present invention is to provide an apparatus and method using a hand held device to provide wireless cursor and application control.

To achieve the above object, the present invention provides an apparatus for cursor control and method thereof. According to one embodiment of the invention, the apparatus includes a cell phone comprising a transceiver communicating with a base station, a wireless communication module, an optical sensor and a processing unit. The optical sensor detects movement. The processing unit calculates a position differential according to the detected movement, and transmits the position differential to a device via the wireless communication module to control cursor activity accordingly, and operate an application on the specific device according to the cursor activity.

The wireless communication module further detects whether the device is present, and the sensor detects movement from any device detected.

The wireless communication module is a radio-frequency (RF) transmitter or an infrared transmitter, and the device is a desktop computer or a portable computer.

According to another embodiment of the present invention, the apparatus includes a wireless communication module, a camera module and a processing unit. The camera module captures a first image and a second image. The processing unit calculates a position differential according to the images, and transmits the position differential to a device via the wireless communication module to control cursor activity accordingly, and operate an application on the device according to the cursor activity.

Similarly, the wireless communication module further detects whether the device is present, and the camera module captures the images from any device detected.

The processing unit calculates the position differential by tracking movement of an object between the images.

The wireless communication module is a radio-frequency (RF) transmitter or an infrared transmitter, and the device is a desktop computer or a portable computer.

According to still another embodiment of the present invention, a method for use between a hand held device integrated with a pointing capability and a specific device is provided. First, the hand held device transmits a direction generated using the pointing capability to the specific device. Then, the specific device performs instructions according to the direction. The cursor activity on the specific device is further controlled and an application on the specific device is further operated in response to the instructions.

The specific device comprises a desktop computer, a portable computer, or a portable device providing the application, such as a digital dictionary. The hand held device comprises a cell phone, a personal digital assistant, or others.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating the architecture of the apparatus for cursor control according to a first embodiment of the present invention;

FIGS. 2A and 2B are schematic diagrams illustrating button locations;

FIG. 3 is a flowchart showing the method for cursor control according to the first embodiment of the present invention;

FIG. 4 is a schematic diagram illustrating the architecture of the apparatus for cursor control according to a second embodiment of the present invention; and

FIG. 5 is a flowchart showing the method for cursor control according to the second embodiment of the present invention.

### DESCRIPTION

The present invention provides an apparatus integrated with a hand held device to wirelessly control cursor activity and operate applications on specific devices, such as desktop computers and portable computers, devices providing an application, such a digital dictionary, and others.

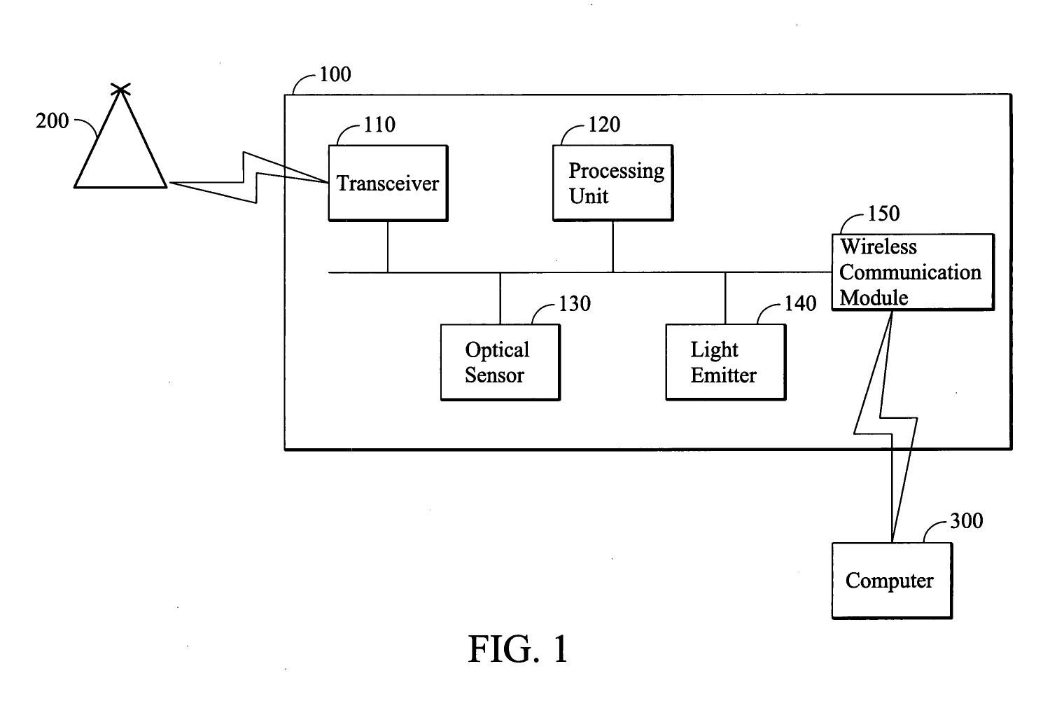

FIG. 1 is a schematic diagram illustrating the architecture of the apparatus for cursor control according to a first embodiment of the present invention. The apparatus of the first embodiment of the present invention integrates features of a cell phone and an optical mouse for controlling cursor activity on the devices, such as desktop and portable computers, and applications on the devices. It is noted that although the first embodiment of the present invention is disclosed herein from the perspective of a cell phone, the cell phone can be replaced by other hand held devices, such as PDAs.

The apparatus 100 includes at least a cell phone comprising a transceiver 110, a processing unit 120, an optical sensor 130, a light emitter 140, and a wireless communication module 150. The transceiver 110 is also a communication module, such as a radio-frequency (RF) module communicating with a base station 200. The transceiver 110 is a cell phone main component providing communication with other cell phones via the base station 200, thereby providing the apparatus with a telecommunication capability. It is understood that the apparatus 100 may also include other cell phone components, such as LCD monitor, keyboard, speaker, central processing unit, storage device, or others.

The optical sensor 130 operates as a CMOS image sensor. The optical sensor 130 detects a movement of the apparatus 100 by detecting light from the light emitter 140. The light emitter 140 may be an LED (Light Emitting Diode). It is noted that the optical sensor 130 may be replaced by other sensor operated in different manners, such as a sensor detecting a movement of a wheel. The processing unit 120 may be a sensor IC coupled to the optical sensor 130, the light emitter 140, and the wireless communication module 150. The processing unit 120 receives detected movement from the optical sensor 130, and calculates a position differential accordingly. The processing unit 120 then transmits the position differential to a computer 300 via the wireless communication module 150. The computer 300 then controls a cursor according to the position differential. The wireless communication module 150 may be a radio-frequency (RF) transmitter, an infrared transmitter, or other. The wireless communication module 150 further detects the computer 300 in the vicinity of the apparatus 100, and returns the result to the processing unit 120. The processing unit 120 enables function of the optical sensor 130 and the light emitter 140 if the computer 300 is detected. Additionally, the apparatus 100 may further include a key triggering the cursor control function or detection of the wireless communication module 150.

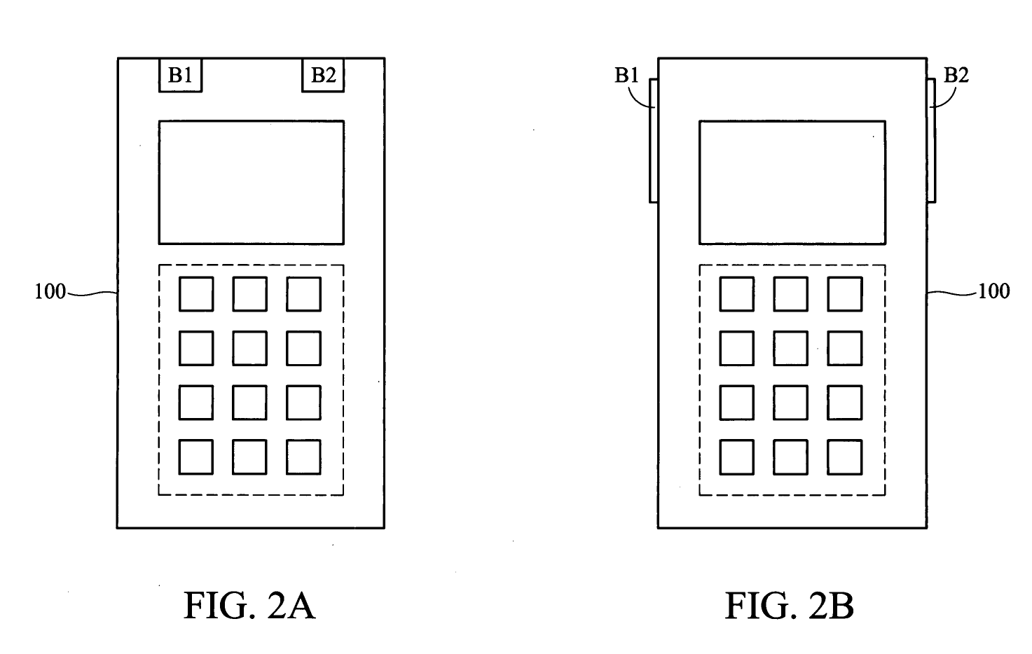

The apparatus 100 further includes a first button B1 and a second button B2 to respectively generate a first signal and a second signal. The first and second buttons are similar to the left and right buttons of a mouse. When the button is pressed, the processing unit 120 transmits the corresponding signal to the computer 300 via the wireless communication module 150. For convenience, the button locations can be designed as shown in FIGS. 2A and 2B. It is understood that the first button B1 and the second button B2 can comprise additional buttons, or original buttons, such as menu key, volume adjustment key or others of a cell phone. Additionally, the buttons may be configured as hot keys for specific functions, such as Internet browsing, email management, and others. Therefore, the apparatus 100 can control the cursor activity and operate an application, such as a digital dictionary on the computer 300.

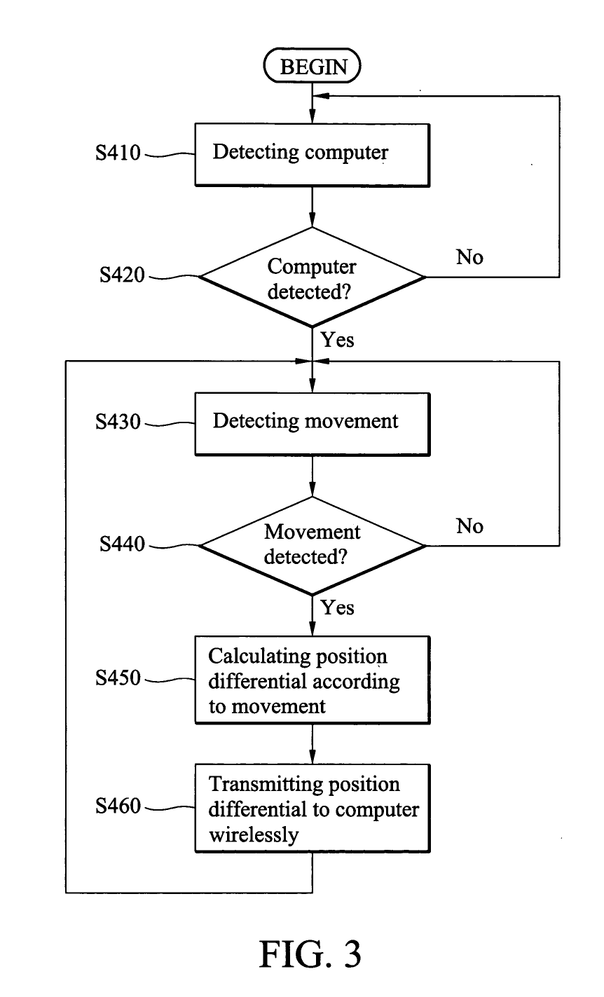

FIG. 3 is a flowchart showing the method for cursor control according to the first embodiment of the present invention.

Once the cursor control function is directed, first, in step S410, the wireless communication module 150 detects whether any computer is present in vicinity of the apparatus 100. If not (No in step S420), the flow returns to step S410. If yes (Yes in step S420), in step S430, the optical sensor 130 detects movement of the apparatus 100. If no movement is detected (No in step S440), the flow returns to step S430. If one movement is detected (Yes in step S440), in step S450, the processing unit 120 calculates a position differential according to the detected movement, and in step S460, transmits the position differential to the computer via the wireless communication module 150 to control cursor activity of the computer accordingly. Thereafter, the steps S430˜S460 repeat until cursor control function is terminated. It is understood that the applications on the computer can be therefore controlled.

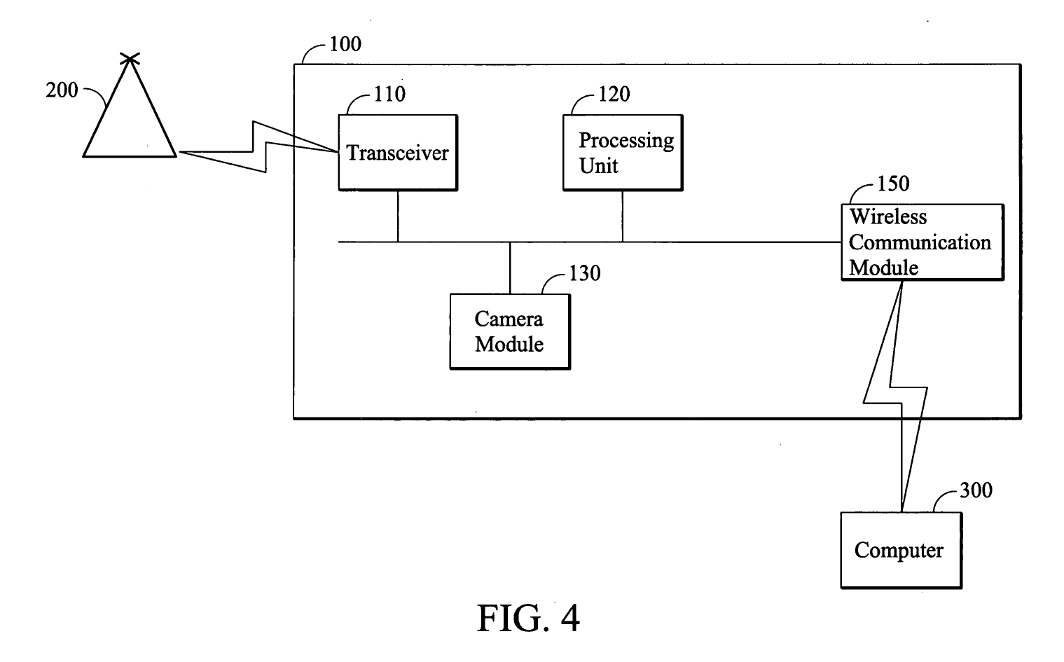

FIG. 4 is a schematic diagram illustrating the architecture of the apparatus for cursor control according to a second embodiment of the present invention. The apparatus of the second embodiment of the present invention integrates features of a cell phone with a digital camera for controlling cursor activity on the devices, such as desktop and portable computers, and applications on the devices. Similar components in the first and second embodiment are referred to using like designations.

The apparatus 100 includes at least a transceiver 110, a processing unit 120, a camera module 160, and a wireless communication module 150. The transceiver 110 communicates with a base station 200. The transceiver 110 provides communication ability with other cell phones via the base station 200. The camera module 160 may comprise a digital camera lens. The camera module 160 captures images at a predetermined interval. In the second embodiment, the optical sensor and the light emitter are replaced by the camera module. It is understood that if the apparatus 100 is only a digital camera integrated with a pointing capability, the transceiver 110 as the main component of a cell phone providing the telecommunication capability can be removed from the apparatus 100 in the second embodiment.

The processing unit 120 receives images from the camera module 160, and calculates a position differential by tracking movement of an object between two successive images. The processing unit 120 then transmits the position differential to a computer 300 via the wireless communication module 150. The computer 300 then controls the cursor according to the position differential.

The wireless communication module 150 may be a radio-frequency (RF) transmitter, an infrared transmitter, or other, detecting whether the computer 300 is present in vicinity of the apparatus 100, and returns the result to the processing unit 120. The processing unit 120 enables function of the camera module 160 if the computer 300 is detected. Additionally, the apparatus 100 may include a key for triggering cursor control function or detection of the wireless communication module 150.

Similarly, the apparatus 100 further includes a first button B1 and a second button B2 to respectively generate a first signal and a second signal. The first and second buttons are similar to the left and right buttons of a mouse. When the button is pressed, the processing unit 120 transmits the corresponding signal to the computer 300 via the wireless communication module 150. It is understood that the first button B1 and the second button B2 may be additional buttons or original buttons. Additionally, the buttons may be configured as hot keys for specific functions. Similarly, the apparatus 100 can therefore control the applications on the computer 300.

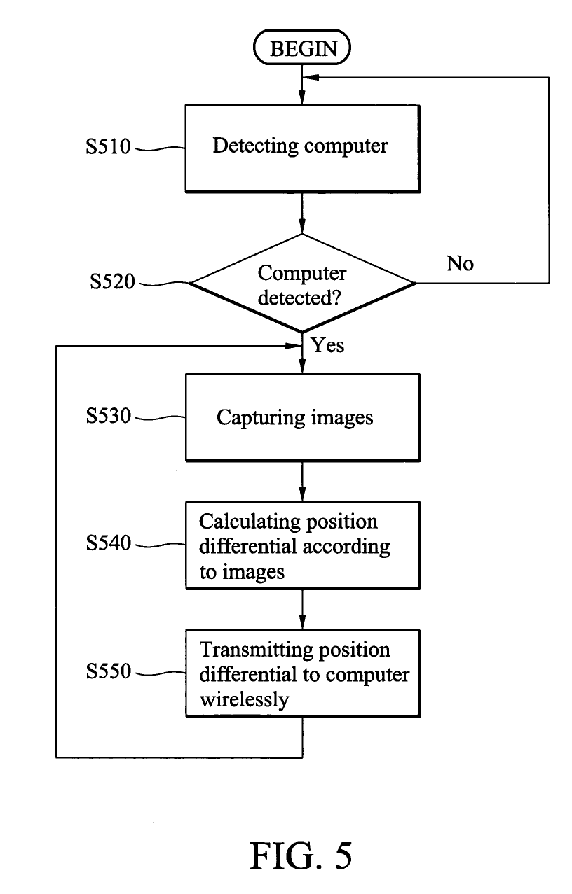

FIG. 5 is a flowchart showing the method for cursor control according to the second embodiment of the present invention.

Once cursor control function is directed, first, in step S510, the wireless communication module 150 detects whether any computer is present in vicinity of the apparatus 100. If not (No in step S520), the flow returns to step S510. If yes (Yes in step S520), in step S530, the camera module captures images at a predetermined interval. Then, in step S540, the processing unit 120 calculates a position differential according to the captured pictures. The processing unit 120 calculates the position differential by tracking movement of an object between two successive images. The object may be predefined or detected using any object detection mechanism. Then, in step S550, the processing unit 120 transmits the position differential to the computer via the wireless communication module 150 to control cursor activity of the computer accordingly. Thereafter, the steps S530˜S550 repeat until cursor control function is terminated.

It is understood that other embodiments of the present invention can integrated with portable devices, such as PDA (Personal Digital Assistant) instead of the cell phone to control the cursor activity and operate the applications on the specific devices, such as desktop and portable computers.

According to still another embodiment of the present invention, a method for use between a hand held device, such as a cell phone, a personal digital assistant, or others integrated with a pointing capability and a specific device, such as a desktop computer, a portable computer, or a portable device providing an application, such as a digital dictionary is provided. The hand held device can transmit a direction generated using the pointing capability to the specific device, and the specific device can perform predetermined instructions accordingly. The cursor activity on the specific device can be controlled and an application on the specific device can be operated in response to the instructions.

The present invention thus provides an apparatus and method integrated with a hand held device to wirelessly control cursor activity and operate applications, thereby providing quicker, convenient and more accurate cursor control and application operation, as well as reducing the number of necessary extra devices.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. An apparatus for cursor control, comprising:
a hand held device comprising a transceiver communicating with a base station, thereby providing the apparatus with a telecommunication capability;
a wireless communication module;
a sensor detecting movement; and
a processing unit to calculate a position differential according to the detected movement, and transmit the position differential to a device via the wireless communication module to control cursor activity accordingly.

2. The apparatus of claim 1 wherein the wireless communication module further detects whether the device is present, and the sensor detects the movement if the device is detected.

3. The apparatus of claim 1 wherein the wireless communication module comprises a radio-frequency (RF) transmitter or an infrared transmitter.

4. The apparatus of claim 1 wherein the device comprises a desktop computer or a portable computer.

5. The apparatus of claim 1 wherein the device further comprises an application to be operated by the apparatus according to the cursor activity.

6. The apparatus of claim 1 wherein the hand held device comprises a cell phone.

7. The apparatus of claim 1 wherein the sensor comprises an optical sensor or a sensor detecting movement of a wheel.

8. An apparatus for cursor control, comprising:
a wireless communication module;
a camera module to capture a first image and a second image; and
a processing unit to calculate a position differential according to the first and second images, and
transmit the position differential to a device via the wireless communication module to control cursor activity accordingly.

9. The apparatus of claim 8 wherein the wireless communication module further detects whether the device is present, and the camera module captures the first and second images if the device is detected.

10. The apparatus of claim 8 wherein the wireless communication module comprises a radio-frequency (RF) transmitter or an infrared transmitter.

11. The apparatus of claim 8 wherein the device comprises a desktop computer or a portable computer.

12. The apparatus of claim 8 wherein the position differential is calculated by tracking movement of an object between the first and second images.

13. The apparatus of claim 8 wherein the device further comprises an application to be operated by the apparatus according to the cursor activity.

14. A method for cursor control, comprising the steps of:
detection of a movement by a hand held device;
calculating a position differential according to the detected movement; and
transmission of the position differential by the hand held device to a device wirelessly to control cursor activity accordingly.

15. The method of claim 14 further comprising detecting whether the device is present, with movement detection performed if the device is detected.

16. The method of claim 14 wherein the position differential is transmitted using radio-frequency (RF) or infrared.

17. The method of claim 14 further comprising capturing a first image and a second image by the hand held device to detect the movement.

18. The method of claim 17 further comprising calculating the position differential by tracking movement of an object between the first and second images.

19. The method of claim 14 further comprising operating of an application by the hand held device according to the cursor activity.

20. The method of claim 19 wherein the device comprises a desktop computer, a portable computer, or a portable device providing the application.

21. The method of claim 14 wherein the hand held device comprises a cell phone or a personal digital assistant.

22. A method for use between a hand held device integrated with a pointing capability and a specific device, comprising the steps of:
transmission of a direction generated using the pointing capability by the hand held device to the specific device; and
performing instructions on the specific device according to the direction.

23. The method of claim 22 further comprising controlling cursor activity on the specific device in response to the instructions.

24. The method of claim 22 further comprising operating an application on the specific device in response to the instructions.

25. The method of claim 24 wherein the specific device comprises a portable device providing the application, and the application comprises a digital dictionary.

26. The method of claim 22 wherein the specific device comprises a desktop computer or a portable computer.

27. The method of claim 22 wherein the hand held device comprises a cell phone or a personal digital assistant.
